(19) United States
(12) Patent Application Publication
(10) Pub. No.: US 2024/0295579 A1
(43) Pub. Date: Sep. 5, 2024

(54) IMPACT DETECTION DEVICE

(71) Applicant: TOSHIBA TEC KABUSHIKI KAISHA, Tokyo (JP)

(72) Inventor: Hidetoshi Murao, Mishima Shizuoka (JP)

(21) Appl. No.: 18/539,317

(22) Filed: Dec. 14, 2023

(30) Foreign Application Priority Data
Mar. 2, 2023 (JP) 2023-032134

(51) Int. Cl. G01P 15/03

(52) U.S. Cl. CPC G01P 15/036; G01H 11/02

(57) ABSTRACT

According to one embodiment, an impact detection device includes a mobile body having mass, a supporting section, and a holding section. The supporting section includes a fixed end to be fixed to a detection target object, includes an attachment section, to a halfway position in a longitudinal direction of which separated from the fixed end the mobile body is attached, and is deformed between the fixed end and the attachment section if acceleration exceeding a fixed threshold was caused in the mobile body by impact applied to the detection target object. The holding section holds the mobile body moved by the deformation of the supporting section in a moving destination.

### CROSS-REFERENCE TO RELATED APPLICATION

This application is based upon and claims the benefit of priority from Japanese Patent Application No. 2023-032134, filed on Mar. 2, 2023, the entire contents of which are incorporated herein by reference.

### FIELD

Embodiments described herein relate generally to, for example, an impact detection device that detects impact applied to an image forming apparatus such as a copying machine or a printer during transportation of the image forming apparatus.

### BACKGROUND

An image forming apparatus such as a copying machine or a printer installed in a workplace includes a fixing device that heats a toner image transferred onto paper and fixes the toner image on the paper. For example, there is known a technique for, in order to prevent an outbreak of fire from the fixing device if an earthquake occurs, detecting vibration applied to the image forming apparatus and interrupting energization to the fixing device.

During transportation after shipment from a manufacturing factory, impact is sometimes applied to the image forming apparatus from the outside to cause serious damage to the image forming apparatus. In this case, it can only be estimated based on an exterior of a packing material, a state of a damaged part, and the like what kind of impact is caused the damage.

Therefore, a method of attaching an accelerometer to the image forming apparatus and measuring the strength of the impact is conceivable. However, this is unrealistic because a lot of labor and cost are required in order to attach accelerometers to all image forming apparatuses. Since the image forming apparatus is not in an energized state during the transportation, it is difficult to detect presence or absence of impact using electric power.

### BRIEF DESCRIPTION OF THE DRAWINGS

FIG. 1 is a perspective view illustrating an impact detection device according to a first embodiment;

FIG. 2 is a perspective view illustrating a state in which a mobile body is removed from the impact detection device illustrated in FIG. 1;

FIG. 3 is a perspective view illustrating the mobile body;

FIG. 4 is a front view of the impact detection device;

FIG. 5 is a front view illustrating a state after acceleration exceeding a first threshold occurred in the mobile body of the impact detection device illustrated in FIG. 4;

FIG. 6 is a perspective view illustrating a state in which mobile body of the impact detection device illustrated in FIG. 1 is attached to second attachment sections;

FIG. 7 is a front view of the impact detection device illustrated in FIG. 6;

FIG. 8 is a front view illustrating a state after acceleration exceeding a second threshold occurred in the mobile body of the impact detection device illustrated in FIG. 7;

FIG. 9 is a perspective view illustrating a state in which the mobile body of the impact detection device illustrated in FIG. 1 is attached to third attachment sections;

FIG. 10 is a front view of the impact detection device illustrated in FIG. 9;

FIG. 11 is a front view illustrating a state after acceleration exceeding a third threshold occurred in the mobile body of the impact detection device illustrated in FIG. 10;

FIG. 12 is a diagram for explaining an attachment example of the impact detection device illustrated in FIG. 1;

FIG. 13 is an exploded perspective view illustrating a pedestal and a supporting section in a modification of the first embodiment;

FIG. 14 is a perspective view illustrating another modification of the supporting section illustrated in FIG. 13;

FIG. 15 is a perspective view illustrating an impact detection device according to a second embodiment;

FIG. 16 is a perspective view illustrating a structure in which a first portion of a housing section of the impact detection device illustrated in FIG. 15 is fixed to a distal end of a supporting section;

FIG. 17 is an exploded perspective view illustrating the impact detection device in an exploded state;

FIG. 18 is an exploded perspective view illustrating internal structure of the housing section;

FIG. 19 is a perspective view illustrating a device, which is an application example of the impact detection device illustrated in FIG. 1;

FIG. 20 is a perspective view illustrating a restricting member of the device illustrated in FIG. 19;

FIG. 21 is a front view illustrating a state in which the device is attached to a copying machine;

FIG. 22 is a front view illustrating a vibration detection state by the device illustrated in FIG. 21; and FIG. 23 is a perspective view illustrating a device, which is another application example of the impact detection device illustrated in FIG. 1.

### DETAILED DESCRIPTION

An aspect of embodiments is to provide an impact detection device that can easily and surely detect impact with an inexpensive configuration without using electric power.

In general, according to one embodiment, an impact detection device includes a mobile body having mass, a supporting section, and a holding section. The supporting section includes a fixed end to be fixed to a detection target object, includes an attachment section, to a halfway position in a longitudinal direction of which separated from the fixed end the mobile body is attached, and is deformed between the fixed end and the attachment section if acceleration exceeding a fixed threshold was caused in the mobile body by impact applied to the detection target object. The holding section holds the mobile body moved by the deformation of the supporting section while keeping a state in which the mobile body is moved.

Embodiments are explained below with reference to the drawings. Note that, in the drawings referred to in the following explanation, components are sometimes simplified or omitted and illustrated in order to facilitate understanding of explanation.

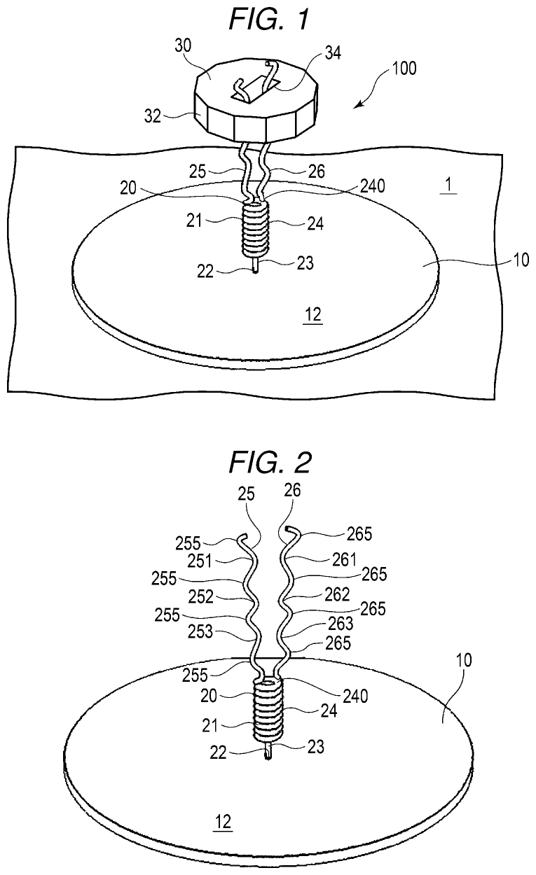

As illustrated in FIGS. 1 to 3, an impact detection device 100 according to a first embodiment includes a pedestal 10, a supporting section 20, and a mobile body 30. The impact detection device 100 is fixed to a flat attachment surface 1 of a detection target object and used. For example, if the detection target object is an image forming apparatus such as a copying machine or a printer, it is possible to detect, with the impact detection device 100, whether the image forming apparatus received impact large enough to cause damage during transportation of the image forming apparatus. In this case, the impact detection device 100 only has to be attached to a predetermined part of the image forming apparatus in advance, if the image forming apparatus is packed and transported by a track or the like.

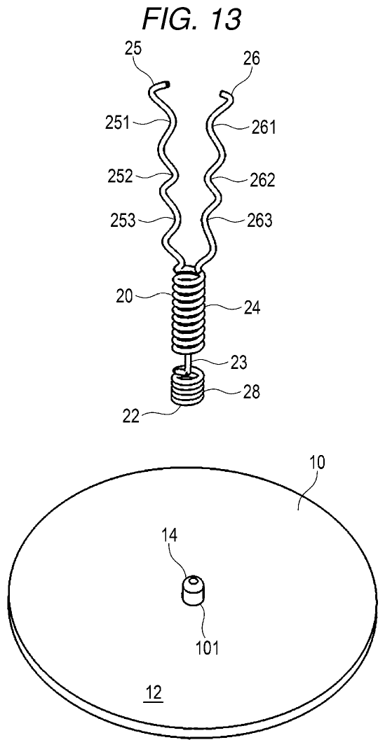

For example, if the impact detection device 100 is attached to a copying machine 200 illustrated in FIG. 12, the impact detection device 100 can be fixed to a paper discharge tray 201 or fixed to a scanner glass 202. Since the copying machine 200 illustrated in FIG. 12 is a copying machine of an in-body paper discharge type, the vicinity of the upper surface of the paper discharge tray 201 (equivalent to the attachment surface 1) is close to the center of gravity of the copying machine 200. Therefore, if the impact detection device 100 is fixed to the paper discharge tray 201, it is easy to detect from which direction impact was applied to the copying machine 200. Since the copying machine 200 of the in-body paper discharge type includes a scanner unit 210 in a cantilever state, the scanner unit 210 easily vibrates up and down. Therefore, it is effective to attach the impact detection device 100 to the scanner unit 210 that is affected most if the copying machine 200 receives impact.

As illustrated in FIGS. 1 and 2, the pedestal 10 of the impact detection device 100 is formed by a substantially disk-like magnetic body. If the impact detection device 100 is attached to the detection target object, the pedestal 10 is fixed to the attachment surface 1 of the detection target object. To fix the pedestal 10 to the attachment surface 1, for example, a double-sided tape can be used. Alternatively, the pedestal 10 may be formed by a magnetic body magnetized in a direction in which repulsion is not caused between the pedestal 10 and the mobile body 30 explained below. By forming the pedestal 10 using such a magnet, if the detection target object is a magnetic body, the impact detection device 100 can be magnetically attracted and fixed to the attachment surface 1. The shape of the pedestal 10 is not limited to a circular shape. Means for fixing the pedestal 10 to the attachment surface 1 may be any means other than the above.

The supporting section 20 is obtained by, for example, shape-machining an elastically deformable metal wire 21. The supporting section 20 includes a fixed end 22 fixed to the center of the pedestal 10. The fixed end 22 is one end of the metal wire 21. The supporting section 20 can be fixed by, for example, press-fitting the fixed end 22 in a fixing hole provided on a surface 12 of the pedestal 10.

The supporting section 20 includes a linear portion 23 extending from the fixed end 22 in a direction orthogonal to the surface 12 of the pedestal 10. The supporting section 20 includes a coil portion 24 continuing to an end portion of the linear portion 23 opposite to the fixed end 22. The supporting section 20 includes a wavy portion 25 continuing to a side of the coil portion 24 opposite to the linear portion 23. The supporting section 20 includes another wavy portion 26 fixed to a distal end 240 of the coil portion 24 by welding. The supporting section 20 has structure in which the wavy portion 26 separated from the linear portion 23, the coil portion 24, and the wavy portion 25 formed by shape-machining one metal wire 21 is fixed to the distal end 240 of the coil portion 24. The wavy portion 26 is attached symmetrically to the wavy portion 25 with respect to an imaginary line passing the center of the coil portion 24. The number of the wavy portions 25 and 26 is not limited to two. Three or more wavy portions may be provided at equal intervals in the circumferential direction of the distal end 240 of the coil portion 24. The two wavy portions 25 and 26 are expanded as the two wavy portions 25 and 26 separate in the longitudinal direction of the supporting section 20 from the distal end 240 of the coil portion 24.

The wavy portions 25 and 26 alternately include a plurality of trough portions 251, 252, 253, 261, 262, and 263 bent in directions approaching each other and a plurality of ridge portions 255 and 265 bent in directions separating from each other. In this embodiment, each of the wavy portions 25 and 26 includes three trough portions and four ridge portions. The three trough portions 251, 252, and 253 of the wavy portion 25 are present in positions respectively facing three trough portions 261, 262, and 263 of the wavy portion 26. The three pairs of the trough portions 251, 261, 252, 262, 253, and 263 are examples of the “attachment section” described in the claims of this application. That is, the impact detection device 100 in this embodiment includes three attachment sections at different distances from the fixed end 22 in the longitudinal direction of the supporting section 20.

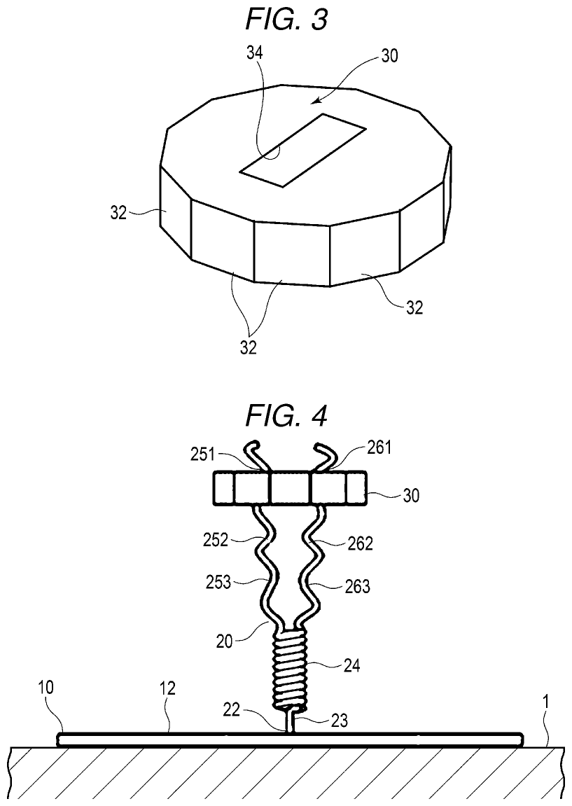

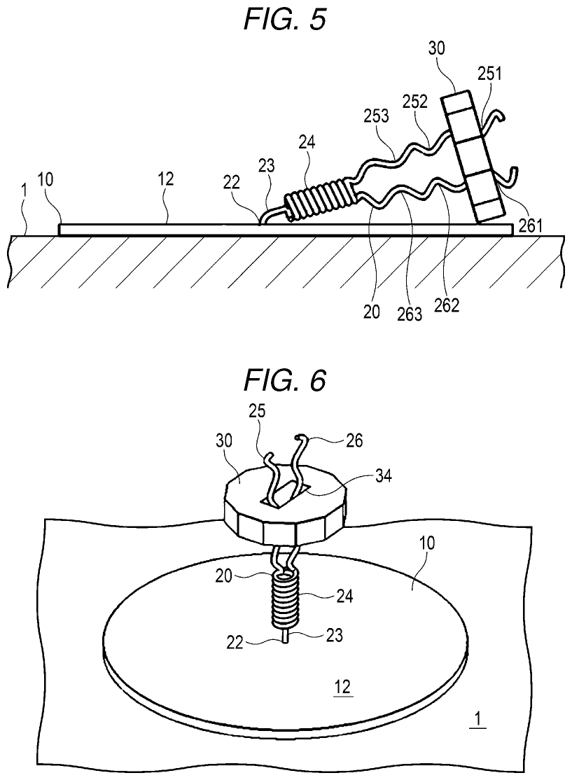

As illustrated in FIG. 3, the mobile body 30 has, for example, a dodecahedral prism shape including twelve rectangular flat surfaces 32 in the outer circumferential portion thereof. The mobile body 30 is formed by, for example, a magnet having constant mass capable of magnetically attracting a magnetic body. The plurality of rectangular flat surfaces 32 present in the outer circumferential portion of the mobile body 30 only have to be surfaces including straight sides that come into contact with the flat surface 12 of the pedestal 10 if the supporting section 20 is deformed into a state illustrated in FIG. 5. The mobile body 30 only has to have a polygonal shape. The number of the flat surfaces 32 included in the outer circumferential portion is not limited to twelve. The mobile body 30 may have a polygonal conical shape or the like and only has to have a shape that does not roll on the surface 12 of the pedestal 10 in a state in which the mobile body 30 is magnetically attracted to the surface 12 of the pedestal 10 as illustrated in FIG. 5.

Alternatively, the mobile body 30 may be formed in, for example, a disk shape not having a flat surface. A plurality of recesses for holding the mobile body 30 to be unable to roll may be provided on the surface 12 of the pedestal 10. In this case, the plurality of recesses only have to be provided side by side in the circumferential direction of the surface 12 of the pedestal 10. The recesses only have to have a shape for allowing the mobile body 30 to fit in the recesses without rolling on the surface 12 of the pedestal 10 after being magnetically attracted to the pedestal 10. The recesses may be, for example, recesses having arcuate bottom surfaces having the same curvature as the curvature of the disk-like mobile body 30.

The mobile body 30 includes, in the center thereof, a rectangular fixing hole 34 piercing through the mobile body 30. A cross section of the fixing hole 34 orthogonal to the axial direction of the mobile body 30 is a rectangle long in one direction. If the mobile body 30 is attached to the supporting section 20, the two wavy portions 25 and 26 of the supporting section 20 are slightly elastically deformed in directions approaching each other, free end sides of the two wavy portions 25 and 26 are inserted through the fixing hole 34 of the mobile body 30, and the two wavy portions 25 and 26 are restored from the elastic deformation. Consequently, both the ends in the longitudinal direction of the fixing hole 34 of the mobile body 30 can be fit in any one of the trough portions 251, 252, 253, 261, 262, and 263 of the wavy portions 25 and 26. A retaining force for the mobile body 30 by the supporting section 20 is a restoration force for the two wavy portions 25 and 26. For example, a state before the mobile body 30 is attached to the supporting section 20 is illustrated in FIG. 2 and an example of a state in which the mobile body 30 is attached to the supporting section 20 is illustrated in FIG. 1. Since the mobile body 30 includes the fixing hole 34 having the rectangular shape in cross section, the mobile body 30 does not turn with respect to the supporting section 20 in the state in which the mobile body 30 is attached to the supporting section 20.

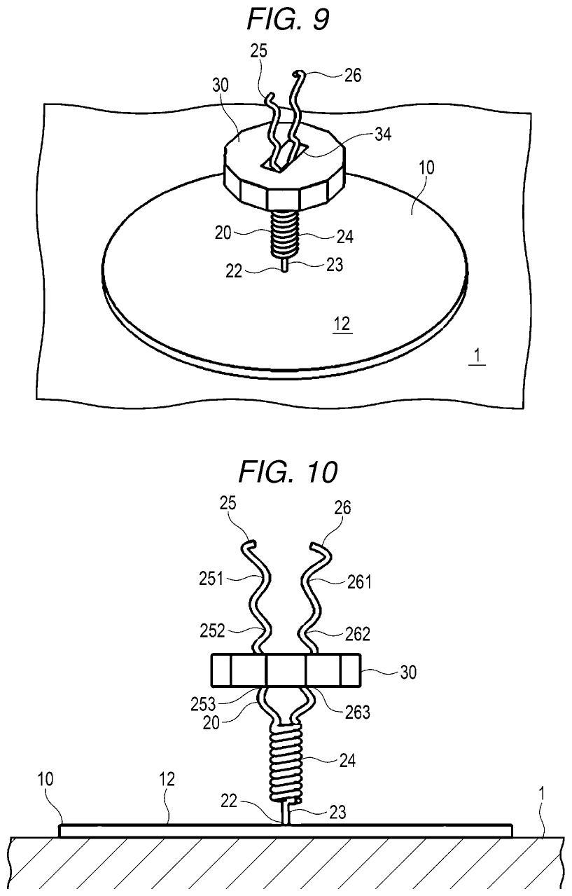

The supporting section 20 includes the three attachment sections as explained above. FIGS. 1, 4, and 5 illustrate states in which the mobile body 30 is attached to a pair of trough portions 251 and 261 (hereinafter referred to as first attachment sections 251 and 261) provided in a position most distant from the fixed end 22 in the longitudinal direction of the supporting section 20. FIGS. 6 to 8 illustrate states in which the mobile body 30 is attached to a pair of trough portions 252 and 262 (hereinafter referred to as second attachment sections 252 and 262) closer to the fixed end 22 than the first attachment sections 251 and 261. FIGS. 9 to 11 illustrate states in which the mobile body 30 is attached to a pair of trough portions 253 and 263 (hereinafter referred to as third attachment sections 253 and 263) closest to the fixed end 22. That is, the mobile body 30 can be attached to any one of a plurality of attachment sections provided at different distances from the fixed end 22 of the supporting section 20.

For example, in the state illustrated in FIG. 4 in which the mobile body 30 is attached to the first attachment sections 251 and 261, if impact is applied to the detection target object, acceleration in a direction and magnitude based on the impact occurs in the mobile body 30. If strong acceleration in a fixed direction occurs in the mobile body 30, the supporting section 20, to which the mobile body 30 is attached, is deformed to curve between the fixed end 22 and the first attachment sections 251 and 261. The deformation of the supporting section 20 occurs generally in the linear portion 23. However, the coil portion 24 also slightly curves. Since the fixed end 22, which is an end portion of one metal wire 21, is perpendicularly fixed to the pedestal 10, the supporting section 20 can be deformed in all directions centering on the fixed end 22.

If acceleration occurring in the mobile body 30 exceeds a certain fixed threshold, the supporting section 20 is greatly deformed to the state illustrated in FIG. 5 and the mobile body 30 comes into contact with the surface 12 of the pedestal 10. A threshold of acceleration for bringing the mobile body 30 into contact with the surface 12 of the pedestal 10 is represented as a first threshold. The mobile body 30 in contact with the surface 12 of the pedestal 10 as illustrated in FIG. 5 is magnetically attracted to the surface 12 of the pedestal 10 by a force stronger than a restoration force of the supporting section 20. Therefore, the mobile body 30 magnetically attracted to the surface 12 of the pedestal 10 maintains the magnetically attracted state to the surface 12 of the pedestal 10 after the acceleration occurring in the mobile body 30 disappeared. That is, in this case, the pedestal 10 functions as the “holding section” described in the claims of this application and holds the mobile body 30 moved by the deformation of the supporting section 20 while keeping a moved state. Note that, since the mobile body 30 of has a plurality flat surfaces 32 in the outer circumferential portion thereof, the mobile body 30 does not roll along the surface 12 in the state in which the mobile body 30 is the magnetically attracted state to the surface 12 of the pedestal 10.

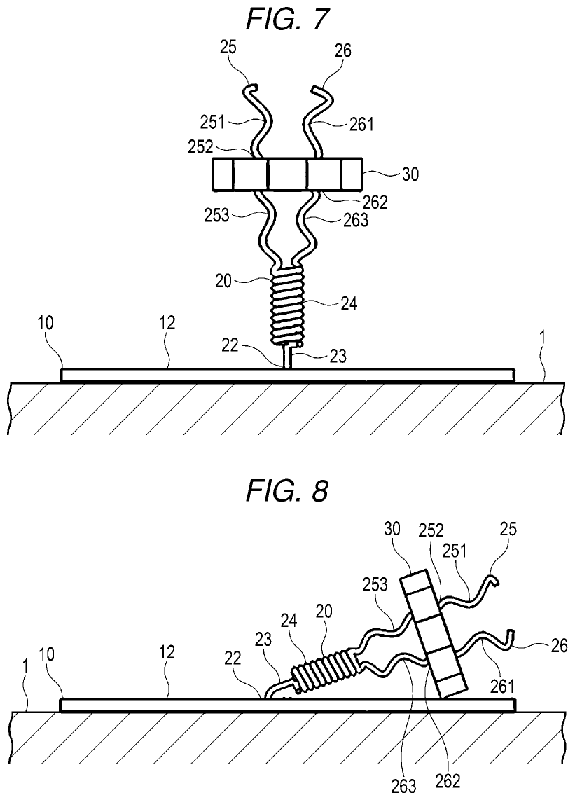

If impact is applied to the detection target object in the state in which the mobile body 30 is attached to the second attachment sections 252 and 262 as illustrated in FIGS. 6 and 7, the supporting section 20 is deformed to the state illustrated in FIG. 8 and the mobile body 30 is magnetically attracted to the surface 12 of the pedestal 10 if acceleration having magnitude exceeding a certain fixed threshold was occurred in the mobile body 30. The threshold of the acceleration at this time is a value larger than the first threshold explained above. This threshold is represented as a second threshold.

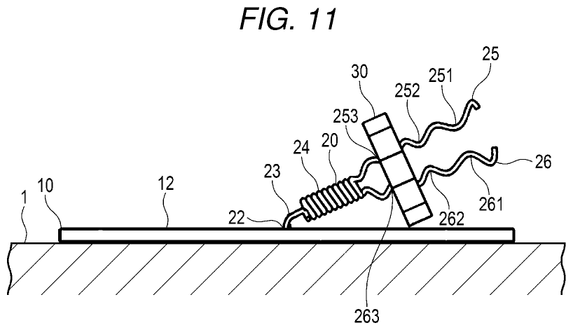

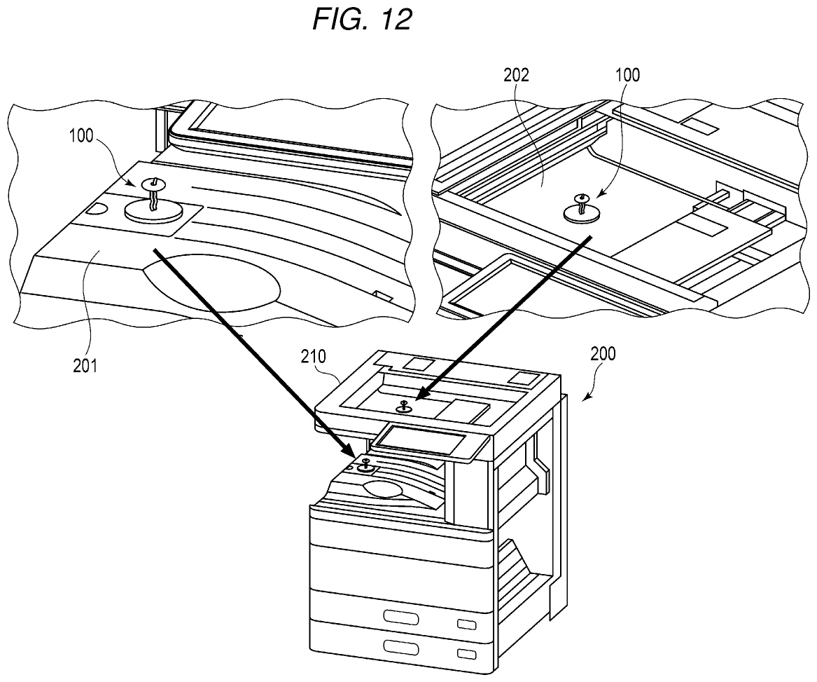

Similarly, if impact is applied to the detection target object in the state in which the mobile body 30 is attached to the third attachment sections 253 and 263 as illustrated in FIGS. 9 and 10, the supporting section 20 is deformed to the state illustrated in FIG. 11 and the mobile body 30 is magnetically attracted to the surface 12 of the pedestal 10 if acceleration having magnitude exceeding the certain fixed threshold occurs in the mobile body 30. The threshold of the acceleration at this time is a value larger than the second threshold explained above. This threshold is represented as a third threshold.

That is, according to this embodiment, it is possible to change the magnitude of impact detectable by the impact detection device 100 by changing an attachment position of the mobile body 30 to the supporting section 20. If the mobile body 30 attached to the first attachment sections 251 and 261 is magnetically attracted to the pedestal 10, it is possible to detect that impact in a degree For causing acceleration exceeding the first threshold in the mobile body 30 was applied to the detection target object. If the mobile body 30 attached to the second attachment sections 252 and 262 is magnetically attracted to the pedestal 10, it is possible to detect that impact in a degree For causing acceleration exceeding the second threshold in the mobile body 30 was applied to the detection target object. If the mobile body 30 attached to the third attachment sections 253 and 263 is magnetically attracted to the pedestal 10, it is possible to detect that impact in a degree For causing acceleration exceeding the third threshold in the mobile body 30 was applied to the detection target object. For example, if it is desired to detect whether relatively strong impact was applied to the detection target object, the mobile body 30 only has to be attached to the third attachment sections 253 and 263. If it is desired to detect whether relatively weak impact has been applied to the detection target object, the mobile body 30 only has to be attached to the first attachment sections 251 and 261.

As explained above, with the impact detection device 100 according to the first embodiment, it is possible to easily and surely detect presence or absence of impact applied to the detection target object with a relatively inexpensive configuration without using electric power. That is, according to this embodiment, a user can determine whether large impact was applied to the detection target object simply by checking whether the mobile body 30 is magnetically attracted to the pedestal 10. Since the mobile body 30 has the plurality of flat surfaces 32 in the outer circumferential portion thereof, the mobile body 30 does not roll in the magnetically attracted state to the pedestal 10. It is possible to learn, from a position where the mobile body 30 is magnetically attracted to the pedestal 10, a direction in which impact is applied to the detection target object.

According to this embodiment, it is possible to change positions (the first attachment sections 251 and 261, the second attachment sections 252 and 262, or the third attachment sections 253 and 263) where the mobile body 30 is attached to the supporting section 20. Therefore, if presence or absence of impact applied to the detection target object is detected, it is possible to change the magnitude of detectable impact stepwise. Operation corresponding to a use is possible. If a plurality of kinds of mobile bodies 30 having different levels of mass are prepared in advance, it is also possible to finely adjust the magnitude of impact to be detected.

According to this embodiment, it is possible to separate the mobile body 30 magnetically attracted to the pedestal 10 from the pedestal 10 and restored to the original state. Therefore, it is possible to reuse the impact detection device 100 attached to the detection target object and used once. If the pedestal 10 is formed of a magnet to be magnetically attracted to the detection target object formed of the magnetic body, the same impact detection device 100 can be reused many times. Note that, if it is unnecessary to reuse the impact detection device 100, the supporting section 20 may be formed of a plastically deformable material rather than the elastically deformable material.

In this embodiment, the pedestal 10 that generates a magnetic attraction force between the pedestal 10 and the mobile body 30 is used as the holding unit that holds the mobile body 30 in the magnetically attracted state to the pedestal 10 while keeping the state. However, not only this, but, for example, the mobile body 30 may be held by the pedestal 10 using other means such as a hook-and-loop fastener. If the detection target object is a magnetic body and the mobile body 30 is a magnet, the pedestal 10 may be omitted and the mobile body 30 may be directly attracted to the attachment surface 1 of the detection target object. In this case, the detection target object functions as the holding unit. Note that, in this case, in order to fix the fixed end 22 of the supporting section 20 to the attachment surface 1, a fixing member such as a suction cup only has to be provided at the fixed end 22.

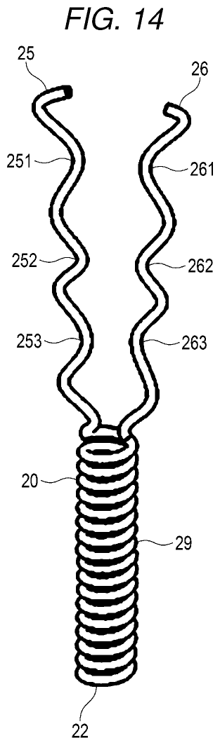

As in a modification illustrated in FIG. 13, a fixed coil 28 may be provided at the fixed end 22 of the supporting section 20 to fix the fixed end 22 of the supporting section 20 to the pedestal 10. In this case, the fixed coil 28 is provided on the opposite side of the coil portion 24 across the linear portion 23 of the supporting section 20. The fixed coil 28 can be formed by one metal wire 21 together with the linear portion 23, the coil portion 24, and the wavy portion 25. A stud 14 over which the fixed coil 28 is fit is provided on the pedestal 10. For example, the stud 14 is inserted into an attachment hole 101 provided in the center of the pedestal 10 and caulked on the rear side of the pedestal 10 to be fixed to the pedestal 10. The inner diameter of the fixed coil 28 is slightly smaller than the outer diameter of the stud 14. The stud 14 is pressed-fit in the fixed coil 28 to fix the fixed coil 28.

In the supporting section 20 according to the modification explained above, the fixed coil 28 is provided separately from the coil portion 24. However, for example, as illustrated in FIG. 14, the linear portion 23 may be eliminated and a coil portion 29 obtained by integrating two coil portions may be provided. In this case, for example, all what should be done is to set the inner diameter of the coil portion 29 slightly smaller than the outer diameter of the stud 14, press-fit the stud 14 in the fixed end 22 of the coil portion 29, and fix the supporting section 20 to the pedestal 10.

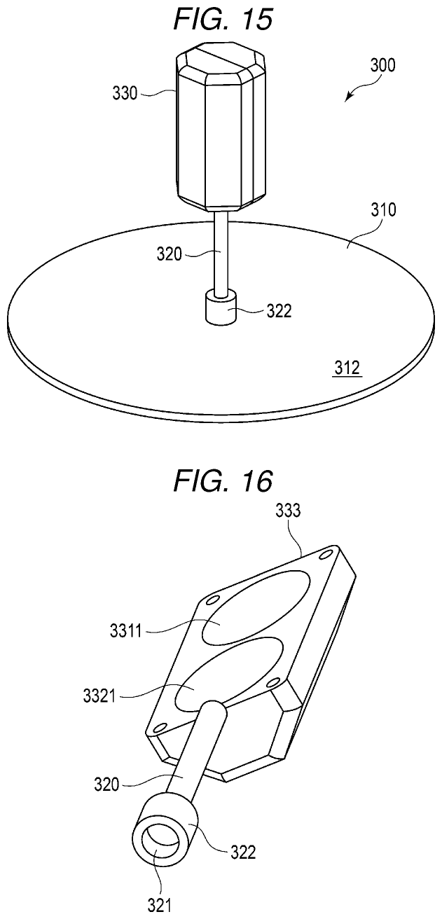

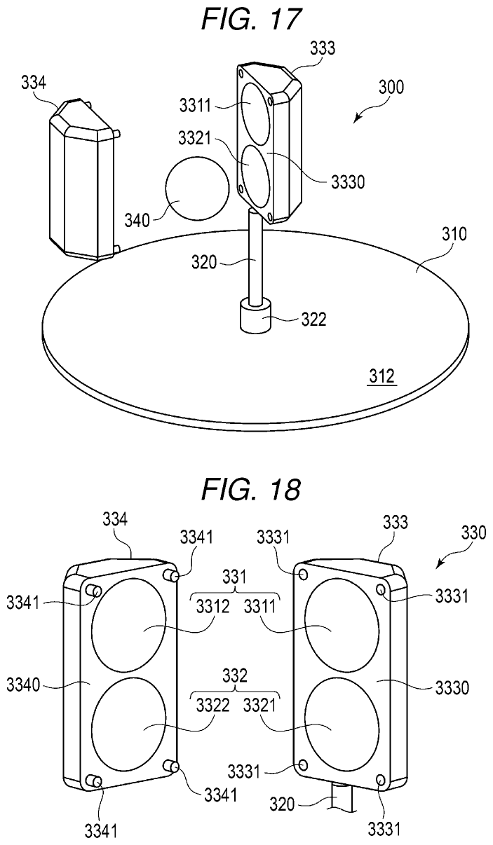

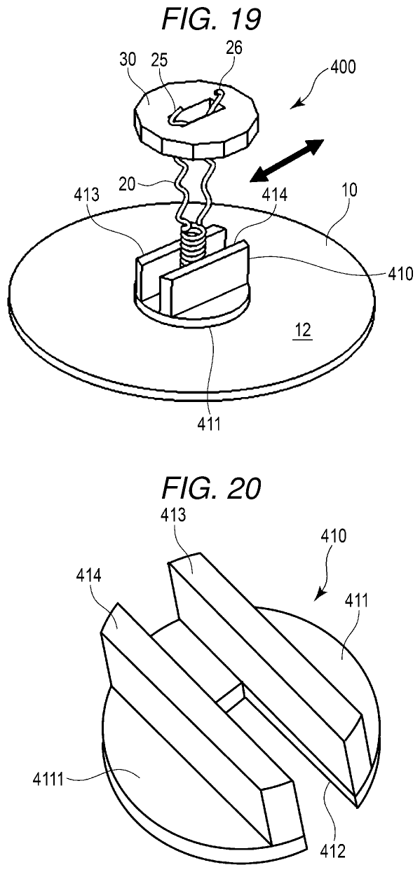

Subsequently, an impact detection device 300 according to a second embodiment is explained with reference to FIGS. 15 to 18.

As illustrated in FIG. 15, the impact detection device 300 includes a pedestal 310, a supporting section 320, and a housing section 330. The pedestal 310 has the same structure as the structure of the pedestal 10 including the stud 14 illustrated in FIG. 13. The supporting section 320 includes, at the proximal end portion thereof, a fixed end 322 fixed to the stud 14 of the pedestal 310. As illustrated in FIG. 16, the fixed end 322 of the supporting section 320 includes a bottomed hole 321 in which the stud 14 is press-fit. The supporting section 320 is an elastically deformable bar-like member. The supporting section 320 is substantially perpendicularly fixed to a surface 312 of the pedestal 310. The housing section 330 is fixed to the distal end of the supporting section 320 separated from the fixed end 322. The housing section 330 has a substantially octagonal prism-shaped external shape. The housing section 330 is not limited to the octagonal prism shape and only has to be formed in a polygonal prism shape.

As illustrated in FIGS. 16 to 18, the housing section 330 includes, on the inside thereof, two housing chambers 331 and 332 for housing a mobile body 340. The two housing chambers 331 and 332 are present in positions separated from the fixed end 322 of the supporting section 320 by different distances. The number of housing chambers is not limited to two. Three or more housing chambers may be provided. The mobile body 340 is, for example, a spherical magnet having predetermined mass. The mobile body 340 is housed and disposed in one of a plurality of housing chambers. The housing chambers 331 and 332 are spherical spaces slightly larger in diameter than the mobile body 340. The shape of the housing chambers 331 and 332 and the shape of the mobile body 340 are not limited to the spherical shapes and may be any shapes if the shapes are similar shapes that allow the housing chambers 331 and 332 and the mobile body 340 to loosely fit.

The housing section 330 includes a first portion 333 fixed to the distal end of the supporting section 320 and a second portion 334 combined with the first portion 333. The first portion 333 and the second portion 334 are formed of, for example, resin. Two hemispherical recesses 3311 and 3321 are present on a joining surface 3330 facing the second portion 334 of the first portion 333. Two hemispherical recesses 3312 and 3322 facing the two recesses 3311 and 3321 of the first portion 333 are present on a joining surface 3340 of the second portion 334 facing the first portion 333. If the joining surface 3330 of the first portion 333 and the joining surface 3340 of the second portion 334 are brought into contact and the first portion 333 and the second portion 334 are combined, the two spherical housing chambers 331 and 332 can be provided on the inside of the housing section 330.

Four fixing holes 3331 are present on the joining surface 3330 of the first portion 333. Four press-fit pins 3341 respectively facing the four fixing holes 3331 of the first portion 333 are present on the joining surface 3340 of the second portion 334. If the mobile body 340 is housed in one of the two housing chambers 331 and 332, the four press-fit pins 3341 of the second portion 334 are respectively press-fit in the four fixing holes 3331 of the first portion 333, and the joining surface 3330 of the first portion 333 and the joining surface 3340 of the second portion 334 are joined, the first portion 333 and the second portion 334 can be combined to assemble the housing section 330.

If impact is applied to the detection target object in a state in which the impact detection device 300 having the structure explained above is fixed to the attachment surface 1 of the detection target object, acceleration occurs in the housing section 330 in which the mobile body 340 is housed. If the acceleration occurring in the housing section 330 exceeds a fixed threshold, the supporting section 320 is deformed to curve until the housing section 330 comes into contact with the surface 312 of the pedestal 310. If the housing section 330 comes into contact with the pedestal 310, the mobile body 340 is magnetically attracted to the pedestal 310 and the housing section 330 is held in a state in which the housing section 330 is in contact with the pedestal 310.

With the impact detection device 300 in this embodiment, the mobile body 340 having mass can be disposed to be housed in one of the two housing chambers 331 and 332 that are present at different distances from the fixed end 322 of the supporting section 320. Therefore, in this embodiment as well, as in the impact detection device 100 in the first embodiment explained above, it is possible to easily and surely detect whether impact is applied to the detection target object. It is possible to change, in two stages, the magnitude of acceleration to be detected.

The impact detection device 100 in the first embodiment can be applied as, for example, a vibration detection device for detecting vibration applied to the detection target object. In this case, for example, a device 400 illustrated in FIG. 19, to which the impact detection device 100 is applied, may be attached to the copying machine 200 illustrated in FIG. 12 to display a warning on a display panel of the copying machine 200, for example, if an earthquake occurred.

The device 400 illustrated in FIG. 19 includes a restricting member 410 for restricting a deformation direction of the supporting section 20 to one direction. The restricting member 410 includes, as illustrated in FIG. 20, a circular fixed plate 411 fixed to the surface 12 of the pedestal 10. The fixed plate 411 includes a cutout section 412 extending in one direction for inserting and disposing the supporting section 20. The restricting member 410 includes two restriction plates 413 and 414 erected on a surface 4111 of the fixed plate 411. The two restriction plates 413 and 414 are present on both sides across the cutout section 412. The two restriction plates 413 and 414 are separated from each other at a distance for allowing the supporting section 20 to be disposed between the two restriction plates 413 and 414 and are parallel to each other. The two restriction plates 413 and 414 restrict the deformation direction of the supporting section 20 to a direction parallel to the restriction plates 413 and 414.

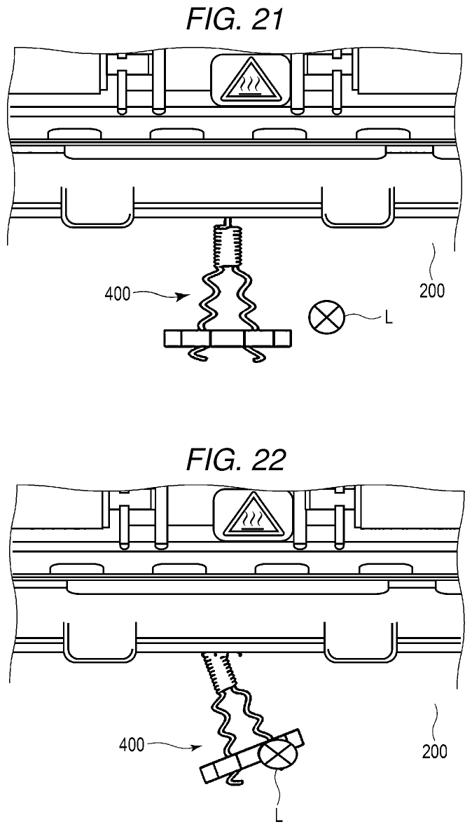

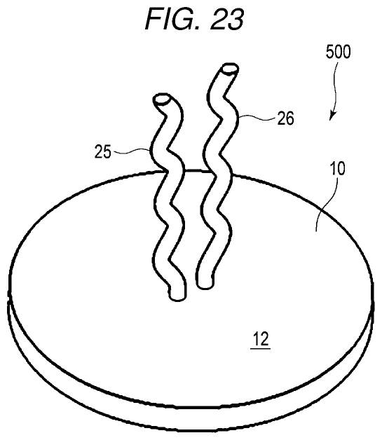

For example, if the device 400 is attached to the copying machine 200 and used, as illustrated in FIGS. 21 and 22, the device 400 is attached to a position where the mobile body 30 blocks a ray L of a sensor if the supporting section 20 is deformed. The deformation direction of the supporting section 20 is adjusted according to the direction of the restricting member 410. The sensor is, for example, a paper conveyance detection sensor and only has to be a sensor including a light emitting unit and a light receiving unit.

If vibration is applied to the copying machine 200 to which the device 400 is attached and acceleration occurs in the mobile body 30, the supporting section 20, the deformation direction of which is restricted by the restricting member 410, is deformed from a state illustrated in FIG. 21 to a state illustrated in FIG. 22 and the mobile body 30 blocks the ray L of the sensor. Consequently, a sensor output changes to “dark” and it is possible to detect that the vibration was applied to the copying machine 200.

Note that, as an application example to the vibration detection device, for example, a device 500 illustrated in FIG. 23 may be used. In the device 500, one ends of the two wavy portions 25 and 26 are fixed to the pedestal 10 to be separated from each other. The mobile body 30 is attached halfway between the wavy portions 25 and 26 and used. As in the first embodiment, if the mobile body 30 is attached halfway between the wavy portions 25 and 26, a direction in which the wavy portions 25 and 26 are deformed if acceleration is caused in the mobile body 30 by vibration is restricted to one direction. That is, the wavy portions 25 and 26 cannot be deformed in an arrangement direction thereof and are deformed in a direction orthogonal to the arrangement direction. Accordingly, the device 500 only has to be attached to a position where the mobile body 30 blocks the ray L of the sensor if the wavy portions 25 and 26 are deformed to be curve in this direction.

Although several embodiments are explained above, these embodiments are presented as examples and are not intended to limit the scope of invention. These new embodiments can be implemented in other various forms. Various omissions, substitutions, and changes can be made without departing from the spirit of the invention. These embodiments and modifications thereof are included in the scope of the invention and included in the inventions described in the claims and a scope of equivalents of the inventions.

What is claimed is:

1. An impact detection device, comprising:
a mobile body having mass;
a supporting section including
a fixed end to be fixed to a detection target object, and
an attachment section to which the mobile body is attached at a position separated from the fixed end,
the supporting section is deformed between the fixed end and the attachment section if acceleration exceeding a fixed threshold occurs in the mobile body by impact applied to the detection target object; and
a holding section configured to hold the mobile body moved by the deformation of the supporting section while keeping a state in which the mobile body is moved.

2. The impact detection device according to claim 1, wherein
the mobile body is a magnetic body, and
the holding section holds the mobile body with a magnetic force.

3. The impact detection device according to claim 1, wherein
the holding section includes a pedestal formed by a magnetic body to which the fixed end is fixed,
the mobile body is a magnet, and
the holding section magnetically attracts the mobile body to the pedestal with a magnetic force.

4. The impact detection device according to claim 3, wherein
the supporting section is an elastic body deformable in all directions centering on the fixed end, and
the mobile body is formed in a polygonal shape, one side of which is in contact with the pedestal in the state in which the mobile body is moved.

5. The impact detection device according to claim 1, wherein
the supporting section includes a plurality of the attachment sections provided at different distances from the fixed end, and
the threshold of the acceleration for deforming the supporting section is changeable by changing the attachment section to which the mobile body is attached.

6. The impact detection device according to claim 1, wherein
the impact detection device is a vibration detection device.

7. The impact detection device according to claim 1, wherein
the detection target object is a copying machine.

8. A method of detecting a presence or an absence of an impact applied to a detection target object without using electric power, comprising:
deforming a supporting section between a fixed end and an attachment section if acceleration exceeding a fixed threshold occurs in a mobile body by impact applied to a detection target object, an impact detection device comprising the mobile body, the supporting section including the fixed end to be fixed to the detection target object, and the attachment section to which the mobile body is attached at a position separated from the fixed end; and
holding, via a holding section, the mobile body moved by the deformation of the supporting section while keeping a state in which the mobile body is moved.

9. The method according to claim 8, wherein
the mobile body is a magnetic body, and
the holding section holds the mobile body with a magnetic force.

10. The method according to claim 8, wherein
the holding section includes a pedestal formed by a magnetic body to which the fixed end is fixed,
the mobile body is a magnet, and
the holding section magnetically attracts the mobile body to the pedestal with a magnetic force.

11. The method according to claim 10, wherein
the supporting section is an elastic body deformable in all directions centering on the fixed end, and
the mobile body is formed in a polygonal shape, one side of which is in contact with the pedestal in the state in which the mobile body is moved.

12. The method according to claim 8, wherein
the supporting section includes a plurality of the attachment sections provided at different distances from the fixed end, and
the threshold of the acceleration for deforming the supporting section is changeable by changing the attachment section to which the mobile body is attached.

13. The method according to claim 8, further comprising:
detecting an occurrence of an earthquake.

14. The method according to claim 8, wherein
the detection target object is a copying machine.

15. A copying machine, comprising:
an image forming device;
a mobile body having mass;
a supporting section including
a fixed end to be fixed to the image forming device, and
an attachment section to which the mobile body is attached at a position separated from the fixed end,
the supporting section is deformed between the fixed end and the attachment section if acceleration exceeding a fixed threshold occurs in the mobile body by impact applied to the image forming device; and
a holding section configured to hold the mobile body moved by the deformation of the supporting section while keeping a state in which the mobile body is moved.

16. The copying machine according to claim 15, wherein
the mobile body is a magnetic body, and
the holding section holds the mobile body with a magnetic force.

17. The copying machine according to claim 15, wherein
the holding section includes a pedestal formed by a magnetic body to which the fixed end is fixed,
the mobile body is a magnet, and
the holding section magnetically attracts the mobile body to the pedestal with a magnetic force.

18. The copying machine according to claim 17, wherein
the supporting section is an elastic body deformable in all directions centering on the fixed end, and
the mobile body is formed in a polygonal shape, one side of which is in contact with the pedestal in the state in which the mobile body is moved.

19. The copying machine according to claim 15, wherein
the supporting section includes a plurality of the attachment sections provided at different distances from the fixed end, and
the threshold of the acceleration for deforming the supporting section is changeable by changing the attachment section to which the mobile body is attached.

20. The copying machine according to claim 15, further comprising a vibration detection device.
